(19) United States
(12) Patent Application Publication
(10) Pub. No.: US 2026/0269143 A1
(43) Pub. Date: Sep. 10, 2026

(54) ELECTROLYTIC CAPACITOR AND PRODUCTION METHOD THEREFOR

(71) Applicant: Panasonic Intellectual Property Management Co., Ltd., Osaka (JP)

(72) Inventors: YOSHIAKI ISHIMARU, Saga (JP); YOSHIKAZU HIRATA, Saga (JP)

(21) Appl. No.: 19/153,580

(22) PCT Filed: Feb. 19, 2024
(86) PCT No.: PCT/JP2024/005842

§ 371 Date: Aug. 4, 2025

(30) Foreign Application Priority Data
Feb. 28, 2023 (JP) 2023-030379

(51) Int. Cl. H01G 9/028; H01G 9/035; H01G 9/055; H01G 9/15

(52) U.S. Cl. CPC H01G 9/028; H01G 9/035; H01G 9/055; H01G 9/151

(57) ABSTRACT

An electrolytic capacitor includes a capacitor element. The capacitor element includes an electrode group including an anode body and a cathode body, and a conductive polymer component disposed between the anode body and the cathode body of the electrode group. The anode body includes a first base material containing a first valve metal, and a first anodization film covering a surface of the first base material. A first anodizing voltage Vfa applied to the first base material for forming the first anodization film is greater than or equal to 400 volts. A ratio Vfa/Vw of the first anodizing voltage Vfa to a rated voltage Vw of the electrolytic capacitor is greater than or equal to 2.10.

### TECHNICAL FIELD

The present disclosure relates to an electrolytic capacitor and a production method therefor.

### BACKGROUND

An electrolytic capacitor includes a capacitor element, and the capacitor element includes an anode body, a cathode body, and a conductive polymer component interposed between the anode body and the cathode body.

PTL 1 discloses “an electrolytic capacitor comprising a hydrogen discharge membrane, wherein the hydrogen discharge membrane includes a hydrogen gas permeable layer that selectively allows hydrogen gas in an amount of greater than or equal to 99 μmol % to permeate when a mixed gas containing hydrogen gas and nitrogen gas in an equimolar amount is brought into contact with the hydrogen gas permeable layer, the hydrogen gas permeable layer is a Pd alloy layer containing Au, and a ratio (average thickness/rated voltage) of an average thickness of an oxide film of an anode to a rated voltage of the capacitor is 1.2 to 2.9 (nm/V)”.

### CITATION LIST

### Patent Literature

PTL 1: Unexamined Japanese Patent Publication No. 2021-132223

### SUMMARY

An aspect of the present disclosure relates to an electrolytic capacitor. The electrolytic capacitor includes a capacitor element. The capacitor element includes an electrode group including an anode body and a cathode body, and a conductive polymer component disposed between the anode body and the cathode body of the electrode group. The anode body includes a first base material containing a first valve metal, and a first anodization film covering a surface of the first base material. A first anodizing voltage Vfa applied to the first base material for forming the first anodization film is greater than or equal to 400 volts. A ratio Vfa/Vw of the first anodizing voltage Vfa to a rated voltage Vw of the electrolytic capacitor is greater than or equal to 2.10.

Another aspect of the present disclosure relates to a method for producing an electrolytic capacitor. The electrolytic capacitor includes a capacitor element. The production method includes: a first step of obtaining an anode body including a first base material and a first anodization film covering a surface of the first base material by subjecting a first base material containing a first valve metal to an anodizing treatment at a first anodizing voltage Vfa; a second step of preparing a cathode body; a third step of obtaining an electrode group including the anode body and the cathode body; and a fourth step of obtaining the capacitor element by interposing a conductive polymer component between the anode body and the cathode body of the electrode group. The first anodizing voltage Vfa is greater than or equal to 400 volts. A ratio Vfa/Vw of the first anodizing voltage Vfa to a rated voltage Vw of the electrolytic capacitor is greater than or equal to 2.10.

According to the present disclosure, the withstand voltage of the electrolytic capacitor can be improved.

### BRIEF DESCRIPTION OF THE DRAWINGS

FIG. 1 is a sectional view schematically illustrating an electrolytic capacitor according to an exemplary embodiment of the present disclosure.

FIG. 2 is a perspective view illustrating a wound body partially developed.

### DESCRIPTION OF EMBODIMENT

In recent years, further improvement of the withstand voltage of an electrolytic capacitor is required.

Hereinafter, an exemplary embodiment of the present disclosure will be described with reference to examples, but the present disclosure is not limited to the examples described below. Although specific numerical values and materials may be provided as examples in the description below, other numerical values and materials may be used as long as the effects of the present disclosure can be obtained. In the present description, the description “numerical value A to numerical value B” includes the numerical value A and the numerical value B, and can be read as “greater than or equal to numerical value A and less than or equal to numerical value B”. In the following description, in a case where lower limits and upper limits related to numerical values of specific physical properties, conditions, or the like are exemplified, any of the exemplified lower limits and any of the exemplified upper limits can be freely combined unless the lower limit is greater than or equal to the upper limit. In a case where a plurality of materials are exemplified, one of the materials may be selected and used singly, or two or more of the materials may be used in combination.

Further, the present disclosure encompasses a combination of matters recited in two or more claims freely selected from a plurality of claims recited in the appended claims. That is, as long as no technical contradiction arises, matters recited in two or more claims freely selected from a plurality of claims recited in the appended claims can be combined.

### [Electrolytic Capacitor]

An electrolytic capacitor according to an exemplary embodiment of the present disclosure includes a capacitor element. The capacitor element includes an electrode group including an anode body and a cathode body, and a conductive polymer component disposed between the anode body and the cathode body of the electrode group. The anode body includes a first base material containing a first valve metal, and a first anodization film covering a surface of the first base material. A first anodizing voltage Vfa applied to the first base material for forming the first anodization film is greater than or equal to 400 volts, and a ratio Vfa/Vw of the first anodizing voltage Vfa to a rated voltage Vw of the electrolytic capacitor is greater than or equal to 2.10.

The anodization film is not limited to a film formed by a method (hereinafter, a first method) for applying a predetermined anodizing voltage to the base material in a state where the base material is immersed in an acidic aqueous solution (hereinafter, an anodizing solution). For example, the anodization film may be formed by subjecting the base material to a heat treatment in a state where the base material is immersed in an anodizing solution (hereinafter, a second method). When the anodization film is formed by the first method, the anodization film having a thickness T corresponding to the anodizing voltage is formed. That is, the anodizing voltage can be obtained from the thickness T of the anodization film. Even when the anodization film is formed by the second method, the anodizing voltage required if the anodization film is formed by the first method can be obtained from the thickness T of the anodization film. That is, the anodizing voltage includes a voltage applied to the base material to form the anodization film having the thickness T and a voltage necessary for forming the anodization film having the thickness T.

The rated voltage Vw is an upper limit voltage defined as a rating, and is a maximum value of a voltage applied between electrodes of the electrolytic capacitor.

Conventionally, studies on the withstand voltage of an electrolytic capacitor have been still insufficient. Therefore, the present inventors have extensively conducted studies on the relationship between the rated voltage Vw and the first anodizing voltage Vfa (thickness of the first anodization film). As a result, the present inventors have newly found that an excellent withstand voltage can be obtained when Vfa is greater than or equal to 400 volts and Vfa/Vw is greater than or equal to 2.10.

The rated voltage Vw may be greater than or equal to 200 volts or greater than or equal to 250 volts. The upper limit of the rated voltage Vw is, for example, less than or equal to 400 volts. From the viewpoint of improving the withstand voltage, the first anodizing voltage Vfa may be greater than or equal to 400 volts, greater than or equal to 420 volts, greater than or equal to 450 volts, or greater than or equal to 500 volts. From the viewpoint of reducing the equivalent series resistance (ESR) and securing the capacitance, the first anodizing voltage Vfa is, for example, less than or equal to 900 volts. From the viewpoint of improving the withstand voltage, Vfa/Vw may be greater than or equal to 2.10, greater than or equal to 2.30, or greater than or equal to 2.50. From the viewpoint of reducing the ESR and securing the capacitance, Vfa/Vw may be less than or equal to 4.00, less than or equal to 3.50, or less than or equal to 3.30.

From the viewpoint of reducing the ESR and increasing the capacitance, it is preferable that a sugar alcohol and/or a liquid component (solvent or electrolytic solution) be attached to the capacitor element. In a case where Vfa is greater than or equal to 400 volts, the first anodization film tends to be large, the ESR tends to increase, and the capacitance tends to decrease. The attachment of the sugar alcohol and the liquid component to the capacitor element can significantly suppress an increase in the ESR and a decrease in the capacitance when Vfa is greater than or equal to 400 volts. The low ESR and the high capacitance due to the attachment of the sugar alcohol and/or the liquid component to the capacitor element can be remarkably obtained, for example, in a case where the rated voltage Vw is greater than or equal to 200 volts (or greater than or equal to 250 volts) and less than or equal to 320 volts and where Vfa/Vw is greater than or equal to 2.10 and less than or equal to 3.30.

### (Anode Body)

The anode body includes the first base material containing the first valve metal, and the first anodization film covering the surface of the first base material.

### (First Base Material)

The first base material has a foil shape or a sheet shape. Examples of the first valve metal include aluminum, tantalum, niobium, and titanium. The first valve metal may be contained in the form of an alloy containing the first valve metal, a compound containing the first valve metal, or the like. The first base material may be, for example, an aluminum foil or an aluminum alloy foil. A thickness of the first base material may be greater than or equal to 15 μm and less than or equal to 300 km.

The surface of the first base material may be roughened by etching or the like. The anode foil with the surface roughened includes a core part and a porous part continuous with the core part. The porous part is provided, for example, on both main surfaces of the first base material. From the viewpoint of securing the capacitance, the ratio of a thickness of the porous part (thickness per one surface) to the total thickness of the first base material may be, for example, greater than or equal to 0.1, or greater than or equal to 0.2. From the viewpoint of securing the core part, the ratio of the thickness T (thickness per one surface) of the porous part to the total thickness of the first base material may be, for example, less than or equal to 0.48, or less than or equal to 0.45.

The etching treatment may be performed by, for example, an alternating current etching method (alternating current electrolyzing method), but is preferably performed by a direct current etching method (direct current electrolyzing method). When the etching treatment is performed by a direct current etching method, a porous part having a tunnel-shaped pit is easily formed, and during the anodizing treatment, an anodization film having a thickness (for example, greater than or equal to 400 nm) necessary for ensuring the withstand voltage is easily formed even in a deep part of the porous part.

A first base material having a relatively large thickness is used for an anode body used for a high-voltage type electrolytic capacitor having a rated voltage of greater than or equal to 200 volts, and a porous part has a relatively large thickness. The thickness of the first base material may be, for example, greater than or equal to 50 μm, or greater than or equal to 100 μm. From the viewpoint of downsizing the capacitor, the thickness of the first base material is, for example, less than or equal to 150 μm. The thickness (thickness per one surface) of the porous part may be, for example, greater than or equal to 10 μm, or greater than or equal to 30 μm. From the viewpoint of the strength of the anode body, the thickness of the porous part (thickness per one surface) is, for example, less than or equal to 50 μm.

From the viewpoint of easily obtaining the anode body advantageous for the high-voltage type electrolytic capacitor having the rated voltage of greater than or equal to 200 volts, the porous part preferably has a tunnel-shaped pit. The tunnel-shaped pit extends in the thickness direction of the porous part, that is, extends from the surface of the porous part toward the core part. In this case, the first anodization film having a large thickness is easily formed up to a deep part of the pit. Further, the conductive polymer component and other components (sugar alcohol, liquid component, and the like) easily enter the deep part of the pit. The extension in the thickness direction of the porous part means that the direction in which the pit extends is parallel to the thickness direction of the porous part or inclined at an angle of less than or equal to 80° with respect to the thickness direction of the porous part. That is, the angle (acute angle) formed by the direction in which the tunnel-shaped pit extends and the thickness direction of the porous part is greater than or equal to 0° and less than or equal to 80°, may be greater than or equal to 0° and less than or equal to 45°, may be greater than or equal to 0° and less than or equal to 30°, or may be greater than or equal to 0° and less than or equal to 15°.

The most frequent pore diameter of the tunnel-shaped pit may be, for example, greater than or equal to 100 nm or greater than or equal to 200 nm, and may be greater than or equal to 300 nm or greater than or equal to 500 nm from the viewpoint of easily forming the first anodization film having a large thickness to the deep part of the pit. From the viewpoint of securing the surface area of the anode body (capacitance), the upper limit of the most frequent pore diameter of the tunnel-shaped pit may be less than or equal to 2000 nm. The most frequent pore diameter of the tunnel-shaped pit is a most frequent pore diameter in a volume-based pore size distribution measured with a mercury porosimeter.

Examples of the shape of the tunnel-shaped pit include a columnar shape (for example, a cylindrical shape or a prismatic shape such as a quadrangular prism shape), a conical shape (for example, a conical shape or a pyramidal shape such as a quadrangular pyramidal shape), and a frustum shape (for example, a truncated cone shape or a truncated pyramid shape such as a truncated quadrangular pyramid shape). The tunnel-shaped pit may branch halfway. In the porous part on one surface side, a part of the tunnel-shaped pit may extend to the core part, and may further extend to the porous part on the other surface side.

The porous part may have a sponge-like pit. The most frequent pore diameter of the sponge-like pit may be greater than or equal to 50 nm and less than or equal to 500 nm, or may be greater than or equal to 80 nm and less than or equal to 300 nm. In a case where the shape of the pit is a sponge shape, the most frequent pore diameter of the pit is a most frequent pore diameter in a volume-based pore size distribution measured by a gas adsorption method.

### (First Anodization Film)

The first anodization film functions as a dielectric layer. The first anodization film is formed by subjecting the first base material to an anodizing treatment. In this case, the first anodization film may contain an oxide (for example, aluminum oxide) of the first valve metal. When the first base material having the porous part on the surface is subjected to an anodizing treatment, the first anodization film is formed so as to cover a metal skeleton constituting the porous part.

A thickness of the first anodization film is preferably greater than or equal to 400 nm, more preferably greater than or equal to 450 nm, or greater than or equal to 500 nm from the viewpoint of improving the withstand voltage of the electrolytic capacitor having a high rated voltage Vw (for example, Vw is greater than or equal to 250 volts). In a case where Vfa is greater than or equal to 400 volts, the first anodization film having a thickness in the above-described range can be formed. From the viewpoint of ensuring the capacitance, the thickness of the first anodization film may be, for example, less than or equal to 1000 nm. The thickness of the first anodization film refers to the thickness of the first anodization film covering an outer surface of the porous part.

The conductive polymer component need not be formed on an end surface of the anode body of the electrolytic capacitor. Meanwhile, it is desirable that the first anodization film be formed on the end surface of the anode body.

### (Cathode Body)

The cathode body includes, for example, a second base material containing at least a second valve metal. The second base material has a foil shape or a sheet shape. Examples of the second valve metal include aluminum, tantalum, niobium, and titanium. The second valve metal may be contained in the form of an alloy containing the second valve metal, a compound containing the second valve metal, or the like. The second base material may be, for example, an aluminum foil or an aluminum alloy foil. A surface of the second base material may be roughened by an etching treatment. The etching treatment can be performed by the method exemplified for the anode body.

### (Second Anodization Film)

From the viewpoint of further improving the withstand voltage, a second anodization film may be formed on the surface of the second base material by an anodizing treatment. That is, the cathode body may include the second base material containing the second valve metal and the second anodization film covering the surface of the second base material.

From the viewpoint of improving the withstand voltage, a second anodizing voltage Vfc applied to the second base material for forming the second anodization film is preferably greater than or equal to 3 volts. In this case, a thickness of the second base material is, for example, greater than or equal to 20 μm and less than or equal to 60 μm. The thickness of the second anodization film is, for example, greater than or equal to 1 nm, preferably greater than or equal to 3 nm. From the viewpoint of reducing the ESR and securing the capacitance, the second anodizing voltage Vfc is, for example, less than or equal to 10 volts.

The ratio Vfc/Vfa of the second anodizing voltage Vfc to the first anodizing voltage Vfa may be greater than or equal to 0.0040, or greater than or equal to 0.0050.

The cathode body may further include a coating layer (inorganic conductive layer) covering the surface of the second base material or the second anodization film. The coating layer may contain a metal or may contain a nonmetal. The coating layer may contain a metal different from the metal constituting the second base material. The metal may be contained in the form of an alloy containing the metal, a compound containing the metal (for example, nitride, carbide, or the like), or the like. Examples of the metal contained in the coating layer include titanium, nickel, and the like. Examples of the nonmetal contained in the coating layer include carbon and the like. A thickness of the coating layer is, for example, greater than or equal to 0.03 μm and less than or equal to 3 μm.

### (Separator)

The electrode group desirably includes a separator disposed between the anode body and the cathode body. A porous sheet can be used as the separator. Examples of the porous sheet include a woven fabric, a nonwoven fabric, and a microporous membrane. The separator is not particularly limited in thickness, and may have a thickness in a range from 10 μm to 300 μm, inclusive. Examples of a material for the separator include cellulose, polyethylene terephthalate, polybutylene terephthalate, polyphenylenesulfide, vinylon, nylon, aromatic polyamide, polyimide, polyamideimide, polyetherimide, rayon, and glass. The conductive polymer component may be attached to a surface of the separator.

### (Conductive Polymer Component)

The conductive polymer component contains a conductive polymer and may contain only the conductive polymer. Alternatively, the conductive polymer component may contain a conductive polymer and a dopant. The conductive polymer component is attached to a surface of the electrode group (the anode body and the cathode body). A layer (solid electrolyte layer) of the conductive polymer component is formed so as to cover at least the anode body (first anodization film). In a case where the anode body has a porous part, the layer of the conductive polymer component may be formed so as to cover a pit inner wall surface of the porous part.

Examples of the conductive polymer include polypyrrole, polythiophene, polyfuran, polyaniline, polyacetylene, and polyaniline. These may be used singly or in combination of two or more thereof or may be a copolymer of two or more monomers. The weight average molecular weight of the conductive polymer is not particularly limited, and ranges, for example, from 1000 to 100,000, inclusive.

In the present specification, polypyrrole, polythiophene, polyfuran, polyaniline, polyacetylene, and the like mean polymers having polypyrrole, polythiophene, polyfuran, polyaniline, polyacetylene, and the like as a basic skeleton, respectively. Thus, polypyrrole, polythiophene, polyfuran, polyaniline, polyacetylene, and the like may also include derivatives thereof. Examples of polythiophene include poly(3,4-ethylenedioxythiophene) (PEDOT).

The conductive polymer may be doped with a dopant. It is desirable to use a polymer dopant from the viewpoint of suppressing dedoping of the dopant from the conductive polymer. Examples of the polymer dopant include anions of, for example, polyvinylsulfonic acid, polystyrenesulfonic acid, polyallylsulfonic acid, polyacrylsulfonic acid, polymethacrylsulfonic acid, poly(2-acrylamido-2-methylpropanesulfonic acid), polyisoprenesulfonic acid, and polyacrylic acid. These polymer dopants may be used singly or in combination of two or more thereof. These polymer dopants may be a homopolymer or a copolymer of two or more monomers. Among them, polystyrenesulfonic acid (PSS) is preferable.

The weight average molecular weight of the dopant is not particularly limited, but preferably ranges, for example, from 1000 to 100,000, inclusive, from the viewpoint of easily forming a homogeneous conductive polymer component layer (solid electrolyte layer).

The conductive polymer component may be poly(3,4-ethylenedioxythiophene) doped with polystyrenesulfonic acid.

### (Sugar Alcohol)

The electrolytic capacitor preferably includes a sugar alcohol. The sugar alcohol is in contact with at least the conductive polymer component. It can also be said that the sugar alcohol is attached to the capacitor element. A hydroxy group of the sugar alcohol and a hydroxy group of the surface of the anode body (first anodization film) are easily bonded, whereby the conductive polymer component in contact with the sugar alcohol is easily attached to the anode body (first anodization film), and the ESR can be reduced. In a case where the thickness of the first anodization film of the anode body is large, it is advantageous for improving the withstand voltage, but the ESR tends to increase. Therefore, when the anode body including the first anodization film having a large thickness is used, the effect of reducing the ESR by the sugar alcohol can be remarkably obtained. Examples of the sugar alcohol include mannitol, sorbitol, xylitol, pentaerythritol, and the like.

The electrolytic capacitor may include sugar in contact with the conductive polymer component. Examples of the sugar include glucose. As in the case of the sugar alcohol, the ESR can be reduced by the sugar.

### (Liquid Component)

The electrolytic capacitor preferably includes an electrolytic solution or a solvent as the liquid component. The liquid component is impregnated into (attached to) the capacitor element. From the viewpoint of improving the withstand voltage, the liquid component is preferably only a solvent not containing a solute (or an electrolytic solution having a low solute concentration). The liquid component is in contact with the conductive polymer component, the anode body (first anodization film), and the cathode body (second anodization film as necessary). The liquid component protects the conductive polymer component. This suppresses oxidative degradation of the conductive polymer component and a decrease in conductivity associated therewith. By impregnating the capacitor element with the liquid component, the contact property between the conductive polymer component and the anodization film is improved. This can reduce the ESR. In a case where the thickness of the first anodization film of the anode body is large, it is advantageous for improving the withstand voltage, but the ESR tends to increase. Therefore, when the anode body including the first anodization film having a large thickness is used, the effect of reducing the ESR by the liquid component can be remarkably obtained. Furthermore, the liquid component restores a defective portion of the anodization film, and an increase in leakage current due to the defect of the anodization film is suppressed.

The electrolytic solution contains a solvent and a solute dissolved in the solvent. The liquid component herein may be a component that is in a liquid state at room temperature (25° C.), or may be a component that is in a liquid state at a temperature when the electrolytic capacitor is used. The solute includes an acid component and a base component. The concentration of the solute is, for example, greater than or equal to 3% by mass and less than or equal to 35% by mass. The concentration of the solute is the sum of the concentration of the acid component and the concentration of the base component.

The solvent may be an organic solvent, an ionic liquid, or a protic solvent. Examples of the solvent include glycol-based solvents such as alkylene glycol (for example, ethylene glycol and propylene glycol), sulfone-based solvents such as sulfolane, lactone-based solvents such as γ-butyrolactone, amide-based solvents such as N-methylacetamide, N,N-dimethylformamide, and N-methyl-2-pyrrolidone, ester-based solvents such as methyl acetate, carbonate-based solvents such as propylene carbonate, ether-based solvents such as 1,4-dioxane, ketone-based solvents such as methyl ethyl ketone, glycerin, and formaldehyde.

As the solvent, a polymer solvent may be used. Examples of the polymer solvent include polyalkylene glycol, polyglycerin, and derivatives thereof. Specifically, the examples of the polymer solvent include polyethylene glycol, polyethylene glycol glyceryl ether, polyethylene glycol diglyceryl ether, polyethylene glycol sorbitol ether, polypropylene glycol, polypropylene glycol glyceryl ether, polypropylene glycol diglyceryl ether, polypropylene glycol sorbitol ether, and polybutylene glycol. The examples of the polymer solvent further include an ethylene glycol-propylene glycol copolymer, an ethylene glycol-butylene glycol copolymer, and a propylene glycol-butylene glycol copolymer.

In the case of a compound such as an alkylene glycol (for example, ethylene glycol), glycerin, or a polyalkylene glycol exemplified as a polymer solvent, it is possible to improve the orientation (crystallinity) of the conductive polymer, improve the conductivity of the conductive polymer component, and reduce the ESR.

The liquid component may contain an acid component. In this case, dedoping of the dopant is suppressed, and a decrease in conductivity of the conductive polymer component due to dedoping is suppressed.

The acid component may include a compound containing an acidic functional group. Examples of the acidic functional group include a carboxy group, a hydroxy group, a sulfo group, a phosphoric acid group, a nitro group, and an oxo group. The acid component may include a carboxylic acid, a phosphoric acid, a sulfonic acid, a boric acid, and/or a salt thereof. More specifically, the acid component includes maleic acid, phthalic acid, benzoic acid, pyromellitic acid, resorcinic acid, and borodisalicylic acid. The compound containing an acidic functional group may be a polycarboxylic acid or a compound having a phenolic hydroxy group.

As the acid component, a polycarboxylic acid and a monocarboxylic acid may be used.

Examples of the polycarboxylic acid include aliphatic polycarboxylic acids ([saturated polycarboxylic acids such as oxalic acid, malonic acid, succinic acid, glutaric acid, adipic acid, pimelic acid, suberic acid, azelaic acid, sebacic acid, 1,6-decanedicarboxylic acid, and 5,6-decanedicarboxylic acid]; and [unsaturated polycarboxylic acids such as maleic acid, fumaric acid, and itaconic acid]), aromatic polycarboxylic acids (such as phthalic acid, isophthalic acid, terephthalic acid, trimellitic acid, and pyromellitic acid), and alicyclic polycarboxylic acids (such as cyclohexane-1,2-dicarboxylic acid and cyclohexene-1,2-dicarboxylic acid).

Examples of the monocarboxylic acid include aliphatic monocarboxylic acids (having 1 to 30 carbon atoms) ([saturated monocarboxylic acids such as formic acid, acetic acid, propionic acid, butyric acid, isobutyric acid, valeric acid, caproic acid, enanthic acid, caprylic acid, pelargonic acid, lauric acid, myristic acid, stearic acid, and behenic acid]; and [unsaturated monocarboxylic acids such as acrylic acid, methacrylic acid, and oleic acid]), aromatic monocarboxylic acids (such as benzoic acid, cinnamic acid, and naphthoic acid), and oxycarboxylic acids (such as salicylic acid, mandelic acid, and resorcinol acid).

Among these, maleic acid, phthalic acid, benzoic acid, pyromellitic acid, and resorcinol acid have high conductivity and are thermally stable, and are preferably used.

Examples of the inorganic acid include a carbon compound, a hydrogen compound, a boron compound, a sulfur compound, a nitrogen compound, and a phosphorus compound. Typical examples of the inorganic acid include phosphoric acid, phosphorous acid, hypophosphorous acid, alkyl phosphoric acid ester, boric acid, fluoroboric acid, tetrafluoroboric acid, hexafluorophosphoric acid, benzenesulfonic acid, and naphthalenesulfonic acid.

Further, a composite compound of an organic acid and an inorganic acid may be used as the acid component. Examples of the composite compound include borodiglycolic acid, borodioxalic acid, and borodisalicylic acid.

The liquid component may contain a base component in addition to the acid component.

Examples of the base component include metal hydroxides such as sodium hydroxide and potassium hydroxide, and nitrogen-containing basic compounds such as aliphatic amines and cyclic amines. Among them, an imidazole compound, a benzimidazole compound, and an alicyclic amidine compound (pyrimidine compound, imidazoline compound) among compounds having an alkyl-substituted amidine group can provide a capacitor having high electric conductivity and excellent impedance performance. Examples of the compound having an alkyl-substituted amidine group include 1,8-diazabicyclo[5,4,0]undecene-7, 1,5-diazabicyclo[4,3,0]nonene-5, 1,2-dimethylimidazolinium, 1,2,4-trimethylimidazoline, 1-methyl-2-ethyl-imidazoline, 1,4-dimethyl-2-ethylimidazoline, 1-methyl-2-heptylimidazoline, 1-methyl-2-(3′heptyl)imidazoline, 1-methyl-2-dodecylimidazoline, 1,2-dimethyl-1,4,5,6-tetrahydropyrimidine, 1-methylimidazole, and 1-methylbenzimidazole. As the base component, a quaternary salt of a compound having an alkyl-substituted amidine group may be used. Specific examples thereof include imidazole compounds, benzimidazole compounds, and alicyclic amidine compounds (pyrimidine compound, imidazoline compound) that are quaternized with an alkyl group or an arylalkyl group having 1 to 11 carbon atoms.

Further, a tertiary amine may also be used as the base component, and examples of the tertiary amine include trialkylamines (such as trimethylamine, dimethylethylamine, methyldiethylamine, triethylamine, dimethyl-n-propylamine, dimethylisopropylamine, methylethyl-n-propylamine, methylethylisopropylamine, diethyl-n-propylamine, diethylisopropylamine, tri-n-propylamine, triisopropylamine, tri-n-butylamine, and tri-tert-butylamine) and phenyl group-containing amines (such as dimethylphenylamine, methylethylphenylamine, and diethylphenylamine). Among them, trialkylamines are preferable because they have high conductivity, and it is more preferable to contain at least one selected from the group consisting of trimethylamine, dimethylethylamine, methyldiethylamine, and triethylamine. As the base component, a secondary amine such as dialkylamines, a primary amine such as a monoalkylamine, or ammonia may also be used.

The base component may be contained in the liquid component in the form of a salt with the acid component. Examples of the salt with the acid component include trimethylamine maleate, triethylamine borodisalicylate, ethyldimethylamine phthalate, mono-1,2,3,4-tetramethylimidazolinium phthalate, and mono-1,3-dimethyl-2-ethylimidazolinium phthalate.

The capacitor element may be a laminated capacitor element or a wound capacitor element. The laminated capacitor element includes a laminated electrode group formed by laminating the anode body and the cathode body. The wound capacitor element includes a wound electrode group formed by winding the anode body and the cathode body.

### [Method for Producing Electrolytic Capacitor]

A method for producing an electrolytic capacitor according to an exemplary embodiment of the present disclosure relates to a method for producing an electrolytic capacitor including a capacitor element, and includes first to fourth steps.

First step: A first base material containing a first valve metal is subjected to an anodizing treatment at a first anodizing voltage Vfa to obtain an anode body. The anode body includes the first base material and a first anodization film covering a surface of the first base material.

Second step: A cathode body is prepared.

Third step: An electrode group including the anode body and the cathode body is obtained.

Fourth step: The capacitor element is obtained by interposing a conductive polymer component between the anode body and the cathode body of the electrode group.

The first anodizing voltage Vfa is greater than or equal to 400 volts. The ratio Vfa/Vw of the first anodizing voltage Vfa to the rated voltage Vw of the electrolytic capacitor is greater than or equal to 2.10.

### (First Step)

In the first step, the first base material subjected to a surface roughening treatment is preferably subjected to an anodizing treatment. The production method preferably includes a step of subjecting the surface of the first base material to the surface roughening treatment by a direct current etching method.

The second step may include a step of subjecting a second base material containing a second valve metal to an anodizing treatment at a second anodizing voltage Vfc. In this case, a second anodization film is formed on the surface of the first base material by an anodizing treatment. That is, the cathode body includes the second base material and the second anodization film covering a surface of the second base material. From the viewpoint of improving the withstand voltage, the second anodizing voltage Vfc is preferably greater than or equal to 3 volts. From the same viewpoint, the ratio Vfc/Vfa of the second anodizing voltage Vfc to the first anodizing voltage Vfa may be greater than or equal to 0.0040.

In the second step, the second base material subjected to a surface roughening treatment may be subjected to an anodizing treatment. The production method may include a step of subjecting the second base material to the surface roughening treatment. The surface roughening treatment on the second base material used for the cathode body may be performed by an alternating current etching method or a direct current etching method.

### (Third Step)

In the third step, the anode body and the cathode body may be laminated to constitute a laminated electrode group, or the anode body and the cathode body may be wound to constitute a wound electrode group. In the third step, a separator may be interposed between the anode body and the cathode body to form the electrode group.

### (Fourth Step)

In the fourth step, a conductive polymer component is attached to the electrode group, and the conductive polymer component is interposed between the anode body and the cathode body. The conductive polymer component may be formed by chemical polymerization or electrolytic polymerization.

The fourth step may include a step of preparing a treatment liquid containing the conductive polymer component, and a step of impregnating the electrode group with the treatment liquid and drying the electrode group to attach the conductive polymer component to the electrode group. The treatment liquid containing the conductive polymer component is a solution or dispersion liquid (hereinafter, also referred to as a polymer dispersion) of the conductive polymer component. Examples of a solvent or dispersion medium of the treatment liquid include water and an organic solvent. The concentration of the conductive polymer component in the treatment liquid may range, for example, from 0.5% by mass to 3% by mass, inclusive. The viscosity of the treatment liquid may range, for example, from 5 mPa·s to 50 mPa·s, inclusive. The impregnation may be performed by immersing the electrode group in the treatment liquid containing the conductive polymer component. The immersion may be performed under atmospheric pressure or under reduced pressure.

In the fourth step, the conductive polymer component may be attached to the electrode group by immersing the electrode group in a polymerization liquid containing a precursor of the conductive polymer and an oxidizing agent and performing chemical polymerization. The oxidizing agent may also serve as a dopant, and a dopant may be separately added to the polymerization liquid.

### (Step A)

The production method preferably includes step A of bringing a sugar alcohol into contact with the conductive polymer component. In step A, the capacitor element to which the sugar alcohol is attached is obtained.

Step A may include step A-1 of impregnating the electrode group with a sugar alcohol solution and drying the electrode group to attach the sugar alcohol to the electrode group. In this case, the fourth step may be performed after step A-1, and the electrode group to which the sugar alcohol is attached may be impregnated with the treatment liquid containing the conductive polymer component. The drying temperature in step A-1 may be higher than or equal to the melting point of the sugar alcohol. The impregnation may be performed by immersion. The impregnation may be performed under atmospheric pressure or under reduced pressure. Step A may include a step of impregnating the capacitor element with the sugar alcohol solution and drying the capacitor element.

Step A may include a step of adding a sugar alcohol to the treatment liquid containing the conductive polymer component in the fourth step. In the fourth step, the sugar alcohol may be attached to the electrode group together with the conductive polymer component by using a treatment liquid containing the conductive polymer component and the sugar alcohol.

### (Step B)

The production method preferably includes step B of impregnating the capacitor element with an electrolytic solution or a solvent as the liquid component. The impregnation in step B may be performed by dropping the liquid component on the capacitor element. The impregnation in step B may be performed under atmospheric pressure or under reduced pressure.

### (Others)

The production method may include a step of sealing the capacitor element impregnated with the liquid component. For example, the step may include: housing the capacitor element and the liquid component in a bottomed case; disposing a sealing member at an opening of the bottomed case; subjecting a part near an opening end of the bottomed case to transverse drawing; caulking the opening end to the sealing member to form a curled part; and disposing a base plate at the curled part. In this way, the electrolytic capacitor may be obtained. After that, the electrolytic capacitor may be subjected to an aging treatment while the rated voltage is applied to the electrolytic capacitor.

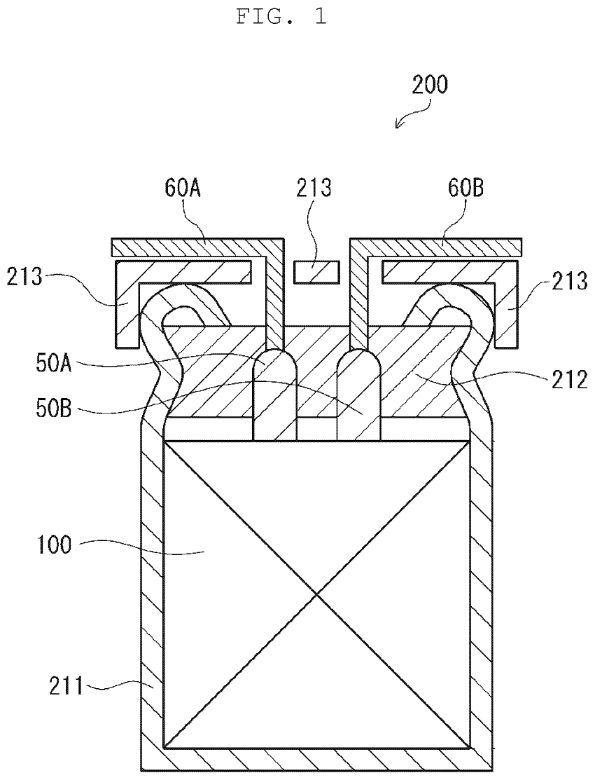

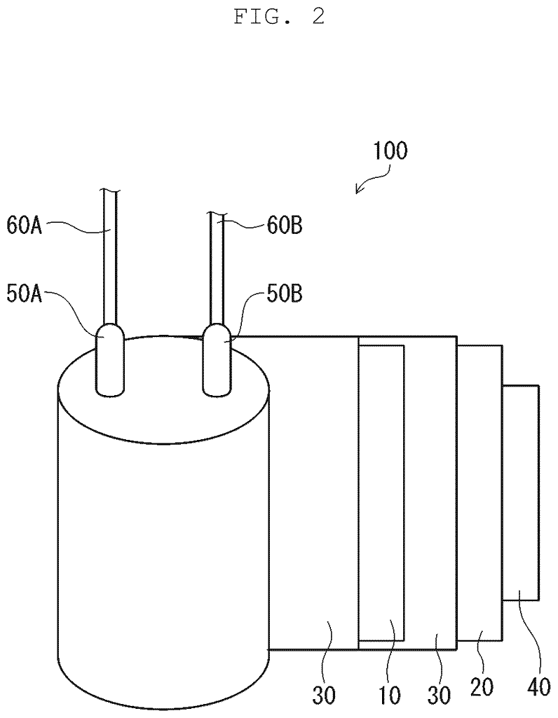

FIG. 1 is a sectional view schematically illustrating an electrolytic capacitor according to one exemplary embodiment of the present disclosure. FIG. 2 is a perspective view illustrating a wound body partially developed.

Electrolytic capacitor 200 includes wound body 100 as a capacitor element. Wound body 100 is configured by winding anode foil 10 (anode body) and cathode foil 20 (cathode body) with separator 30 interposed between anode foil 10 and cathode foil 20. A conductive polymer component is disposed between anode foil 10 and cathode foil 20.

Anode foil 10 and cathode foil 20 are connected to one end of lead tab 50A and one end of lead tab 50B, respectively, and wound body 100 is formed while lead tabs 50A and 50B are wound. Lead tabs 50A and 50B are connected at the other ends to lead wires 60A and 60B, respectively.

Winding stop tape 40 is disposed on an outer surface of cathode foil 20 positioned at an outermost layer of wound body 100, and an end of cathode foil 20 is fixed by winding stop tape 40. When anode foil 10 is prepared by cutting a large foil, wound body 100 may be further subjected to an anodizing treatment in order to provide a dielectric layer on the cut surface.

Electrolytic capacitor 200 includes sealing member 212 that closes an opening of bottomed case 211, and base plate 213 covering sealing member 212. Wound body 100 is housed in bottomed case 211 with lead wires 60A, 60B positioned close to the opening of bottomed case 211. Lead wires 60A, 60B are led out from sealing member 212 and extend through base plate 213. As a material of bottomed case 211, a metal such as aluminum, stainless steel, copper, iron, or brass, or an alloy thereof can be used.

Sealing member 212 is disposed at the opening of bottomed case 211 in which wound body 100 is housed, and an opening end of bottomed case 211 is caulked to sealing member 212 to form a curled part. Then, base plate 213 is disposed at the curled part to seal wound body 100 in bottomed case 211. Sealing member 212 may be an insulating substance, and is preferably an elastic body. Materials having excellent heat resistance such as silicone rubber and fluororubber are preferable.

### SUPPLEMENTARY NOTE

Techniques below are disclosed by the description of the exemplary embodiment.

### (Technique 1)

An electrolytic capacitor including a capacitor element, wherein:
the capacitor element includes an electrode group including an anode body and a cathode body, and a conductive polymer component disposed between the anode body and the cathode body of the electrode group, and
the anode body includes a first base material containing a first valve metal, and a first anodization film covering a surface of the first base material, and
a first anodizing voltage Vfa applied to the first base material for forming the first anodization film is greater than or equal to 400 volts, and
a ratio Vfa/Vw of the first anodizing voltage Vfa to a rated voltage Vw of the electrolytic capacitor is greater than or equal to 2.10.

### (Technique 2)

The electrolytic capacitor according to Technique 1, wherein the cathode body includes a second base material containing a second valve metal, and a second anodization film covering a surface of the second base material, and
a second anodizing voltage Vfc applied to the second base material for forming the second anodization film is greater than or equal to 3 volts.

### (Technique 3)

The electrolytic capacitor according to Technique 2, wherein a ratio Vfc/Vfa of the second anodizing voltage Vfc to the first anodizing voltage Vfa is greater than or equal to 0.0040.

### (Technique 4)

The electrolytic capacitor according to any one of Techniques 1 to 3, wherein the surface of the first base material is roughened by a direct current etching method.

### (Technique 5)

The electrolytic capacitor according to any one of Techniques 1 to 4, wherein a thickness of the first anodization film is greater than or equal to 400 nm.

### (Technique 6)

The electrolytic capacitor according to any one of Techniques 1 to 5, further including a sugar alcohol in contact with the conductive polymer component.

### (Technique 7)

The electrolytic capacitor according to any one of Techniques 1 to 6, further including an electrolytic solution or a solvent.

### (Technique 8)

A method for producing an electrolytic capacitor including a capacitor element, the method including:
a first step of obtaining an anode body including a first base material and a first anodization film covering a surface of the first base material by subjecting the first base material containing a first valve metal to an anodizing treatment at a first anodizing voltage Vfa;
a second step of preparing a cathode body;
a third step of obtaining an electrode group including the anode body and the cathode body; and
a fourth step of obtaining the capacitor element by interposing a conductive polymer component between the anode body and the cathode body of the electrode group, wherein:
the first anodizing voltage Vfa is greater than or equal to 400 volts, and
a ratio Vfa/Vw of the first anodizing voltage Vfa to a rated voltage Vw of the electrolytic capacitor is greater than or equal to 2.10.

### (Technique 9)

The method according to Technique 8, wherein:
the second step includes a step of obtaining the cathode body including a second base material and a second anodization film covering a surface of the second base material by subjecting the second base material containing a second valve metal to an anodizing treatment at a second anodizing voltage Vfc, and
the second anodizing voltage Vfc is greater than or equal to 3 volts.

### (Technique 10)

The method according to Technique 9, wherein a ratio Vfc/Vfa of the second anodizing voltage Vfc to the first anodizing voltage Vfa is greater than or equal to 0.0040.

### (Technique 11)

The method according to any one of Techniques 8 to 10, further including a step of subjecting the surface of the first base material to a surface roughening treatment by a direct current etching method, wherein in the first step, the first base material subjected to the surface roughening treatment is subjected to an anodizing treatment.

### (Technique 12)

The method according to any one of Techniques 8 to 11, further including step A of bringing a sugar alcohol into contact with the conductive polymer component.

### (Technique 13)

The method according to any one of Techniques 8 to 12, further including step B of impregnating the capacitor element with an electrolytic solution or a solvent.

### EXAMPLES

Although the present disclosure will be described below in more detail based on Examples, the present disclosure is not limited to the Examples.

### Example 1

A wound electrolytic capacitor (a diameter of 10 mm and a length of 10 mm) having a rated voltage (Vw) of 320 volts and a rated electrostatic capacitance of 5.6 μF was prepared in the following manner.

### (Preparation of Anode Body)

A surface of an aluminum foil having a thickness of 100 μm was subjected to a surface roughening treatment by a direct current etching method. As a result, a porous part having a tunnel-shaped pit was formed on both surfaces of the aluminum foil. The most frequent pore size of the pit was in the range from 100 nm to 300 nm, inclusive. The thickness of the porous part per one surface was 30 μm. The roughened surface of the aluminum foil (porous part) was subjected to an anodizing treatment at a first anodizing voltage Vfa of 672 volts to form a first anodization film. Thereafter, an anode body was prepared by cutting the anode body into a predetermined size. Vfa/Vw was set to 2.10. A thickness of the first anodization film was 753 nm.

### (Preparation of Cathode Body)

A surface of an aluminum foil having a thickness of 50 μm was subjected to a surface roughening treatment by a direct current etching method. The roughened surface of the aluminum foil was subjected to an anodizing treatment at a second anodizing voltage Vfc of 3 volts to form a second anodization film. Thereafter, a cathode body was prepared by cutting the cathode body into a predetermined size. Vfc/Vfa was 0.0045.

### (Preparation of Wound Body)

An anode lead tab and a cathode lead tab were connected to the anode body and the cathode body, respectively. The anode body and the cathode body were wound with a separator interposed between the anode body and the cathode body while the lead tabs were wound, whereby a wound body (wound electrode group) was formed. Ends of the lead tabs protruding from the wound body were connected to an anode lead wire and a cathode lead wire, respectively. The wound body obtained was chemically converted again to form a anodization film at a cutting end of the anode body. An end of an outer surface of the wound body was fixed with a fastening tape.

### (Preparation of Sugar Alcohol Solution)

Mannitol (melting point of about 165° C. to 169° C.) was dissolved in ion-exchanged water to prepare a mannitol aqueous solution (concentration of 10% by mass). The viscosity of the obtained mannitol aqueous solution was measured and found to be less than or equal to 5 mPa·s.

(Impregnation with Sugar Alcohol Solution)

The wound body was immersed in the mannitol aqueous solution at room temperature in an atmospheric-pressure atmosphere for 5 minutes. Thereafter, the wound body was pulled up from the mannitol aqueous solution. Next, the wound body impregnated with the mannitol aqueous solution was dried at 180° C. for 30 minutes in a drying furnace with a pressure of 1 atm. In this way, the mannitol was attached to the wound body.

### (Preparation of Polymer Dispersion)

By dissolving 3,4-ethylenedioxythiophene and polystyrenesulfonic acid as a dopant in ion-exchanged water, a mixed solution thereof was prepared. While the mixed solution was stirred, iron (III) sulfate (oxidant) was added to the mixed solution to cause a polymerization reaction. Thereafter, the reaction solution was dialyzed to remove an unreacted monomer and an oxidant. In this way, an aqueous dispersion (polymer dispersion) containing a conductive polymer component was obtained. The conductive polymer component was poly (3,4-ethylenedioxythiophene) doped with polystyrenesulfonic acid. The concentration of the conductive polymer component in the polymer dispersion was about 2% by mass. The viscosity of the obtained polymer dispersion was measured and found to be less than or equal to 50 mPa·s.

(Impregnation with Polymer Dispersion)

The wound body to which the mannitol was attached was immersed in the polymer dispersion in a decompressed atmosphere (40 kPa) at room temperature for 15 minutes, and then the wound body was picked up from the polymer dispersion. Next, the wound body was dried at 150° C. for 30 minutes in a drying furnace with a pressure of 1 atm. In this way, the conductive polymer component was attached to the wound body to obtain a capacitor element, and the conductive polymer component and the mannitol were brought into contact with each other.

(Impregnation with Electrolytic Solution)

Triethylamine phthalate (solute) was dissolved in ethylene glycol (solvent) to prepare an electrolytic solution. The capacitor element was impregnated with the electrolytic solution at room temperature in an atmospheric-pressure atmosphere.

### (Sealing of Capacitor Element)

The capacitor element impregnated with the electrolytic solution was sealed to complete the electrolytic capacitor having the structure shown in FIG. 1. Then, an aging treatment was performed at 130° C. for 2 hours while applying the rated voltage Vw. In this way, capacitor A1 was obtained.

Capacitor A1 was evaluated as follows.

### [Evaluation]

### (Short Circuit Rate)

100 capacitors were prepared, and the ratio (percentage) of the number of capacitors in which a short circuit occurred during an aging treatment to the 100 capacitors was determined as the short circuit rate. The initial ESR and the breakdown voltage (BDV) described later were obtained by measuring capacitors other than the capacitors in which the short circuit occurred and averaging the measured values.

### (Initial ESR)

Under an environment of 20° C., the initial ESR (mΩ) at a frequency of 100 kHz was measured using an LCR meter for 4-terminal measurement.

### (Breakdown Voltage)

Under an environment of 20° C., a voltage was applied at a rate of 1.0 V/sec while increasing the voltage, and the BDV (V) at which an overcurrent of 0.5 A flowed was measured.

### Examples 2 and 3

Capacitors A2 and A3 of Examples 2 and 3 were prepared and evaluated in the same manner as in capacitor A1 of Example 1 except that the rated voltage Vw was set to 300 volts or 250 volts and Vfa/Vw was set to 2.24 or 2.69.

### Example 4

Capacitor A4 of Example 4 was prepared and evaluated in the same manner as in capacitor A1 of Example 1 except that the second anodizing voltage Vfc was set to 4.5 volts.

### Example 5

Capacitor A5 of Example 5 was prepared and evaluated in the same manner as in capacitor A1 of Example 1 except that the rated voltage Vw was set to 200 V, the first anodizing voltage Vfa was set to 450 V, and Vfa/Vw was set to 2.25. A thickness of a first anodization film of capacitor A5 was 504 nm.

### Comparative Example 1

Capacitor B1 of Comparative Example 1 was prepared and evaluated in the same manner as in capacitor A1 of Example 1 except that the rated voltage Vw was set to 330 volts and Vfa/Vw was set to 2.04.

### Comparative Example 2

The rated voltage Vw was set to 330 volts, and Vfa/Vw was set to 2.04. The second anodizing voltage Vfc was set to 2 volts. Capacitor B1 of Comparative Example 1 was prepared and evaluated in the same manner as in capacitor A1 of Example 1 except for the above.

### Comparative Example 3

Capacitor B3 of Comparative Example 3 was prepared and evaluated in the same manner as in capacitor A1 of Example 1 except that the rated voltage Vw was set to 200 V, the first anodizing voltage Vfa was set to 350 V, and Vfa/Vw was set to 1.75.

Evaluation results are shown in Table 1. ESRs in Table 1 were expressed as relative values with the ESR of B2 set to 100. Table 1 also shows BDV/Vw. BDV/Vw is one of indices indicating a withstand voltage, and a larger numerical value indicates a higher withstand voltage. In a case where BDV/Vw was greater than or equal to 1.2, the capacitor was evaluated to be excellent in withstand voltage.

TABLE 1

| | Rated | First anodizing | Thickness of | | Second anodizing | |
|---|---|---|---|---|---|---|
| | voltage | voltage Vfa of | first anodizing | | voltage Vfc of | |
| Capacitor | Vw | anode body | voltage of anode | | cathode body | |
| No. | (volts) | (volts) | body (nm) | Vfa/Vw | (volts) | Vfc/Vfa |
| A1 | 320 | 672 | 753 | 2.10 | 3 | 0.0045 |
| A2 | 300 | 672 | 753 | 2.24 | 3 | 0.0045 |
| A3 | 250 | 672 | 753 | 2.69 | 3 | 0.0045 |
| A4 | 320 | 672 | 753 | 2.10 | 4.5 | 0.0067 |
| A5 | 200 | 450 | 504 | 2.25 | 3 | 0.0067 |
| B1 | 330 | 672 | 753 | 2.04 | 3 | 0.0045 |
| B2 | 330 | 672 | 753 | 2.04 | 2 | 0.0030 |
| B3 | 200 | 350 | 392 | 1.75 | 3 | 0.0086 |

| Capacitor | Sugar | | | ESR | BDV | |
|---|---|---|---|---|---|---|
| No. | alcohol | Liquid component | Short circuit rate | (index) | (volts) | BDV/Vw |
| A1 | Mannitol | Phthalic acid | Less than 5% | 70 | 390 | 1.22 |
| | | electrolytic solution | | | | |
| A2 | Mannitol | Phthalic acid | Less than 5% | 75 | 373 | 1.24 |
| | | electrolytic solution | | | | |
| A3 | Mannitol | Phthalic acid | Less than 5% | 76 | 330 | 1.32 |
| | | electrolytic solution | | | | |
| A4 | Mannitol | Phthalic acid | Less than 5% | 80 | 419 | 1.31 |
| | | electrolytic solution | | | | |
| A5 | Mannitol | Phthalic acid | Less than 5% | 55 | 260 | 1.30 |
| | | electrolytic solution | | | | |
| B1 | Mannitol | Phthalic acid | Greater than or equal to | 88 | 370 | 1.12 |
| | | electrolytic solution | 5% and less than 20% | | | |
| B2 | Mannitol | Phthalic acid | Greater than or equal to | 100 | 327 | 0.99 |
| | | electrolytic solution | 20% | | | |
| B3 | Mannitol | Phthalic acid | Greater than or equal to | 81 | 192 | 0.96 |
| | | electrolytic solution | 20% | | | |

In each of the capacitors A1 to A5, the short circuit rate was low, the BDV/Vw was greater than or equal to 1.2, and excellent withstand voltage was obtained. In each of the capacitors A1 to A5, Vfa was greater than or equal to 400 volts, and Vfa/Vw was greater than or equal to 2.10. In addition, Vfc was greater than or equal to 3 volts. In each of the capacitors A1 to A5, the thickness of the first anodization film was greater than or equal to 500 nm, but the ESR was reduced due to an effect such as attachment of a sugar alcohol and an electrolytic solution to the capacitor element.

In the capacitors B1 and B3, Vfa was less than Vw, Vfa/Vw was less than 2.10, the short circuit rates increased, the ratios BDV/Vw were as small as 1.12 and 0.96, respectively, and the withstand voltages decreased. From the results of the capacitor B3, it is found that when Vfa is less than 400 volts, it is difficult to secure the withstand voltage when Vw is greater than or equal to 200 volts.

In the capacitor B2, Vfa/Vw was less than 2.10. In addition, Vfc was less than 3 volts, compared with Vw. In the capacitor B2, the thicknesses of the anodization films were small in both the anode body and the cathode body, the short circuit rate was further increased as compared with the capacitor B1, BDV/Vw was further decreased to 0.99, and the withstand voltage was significantly decreased.

In the capacitors B1 and B2, the ESRs increased. This is presumed to be because Vw was greater than Vfa in the capacitors B1 and B2, a high voltage was applied to the first anodization films during the aging treatment, and the conductive polymer components were locally deteriorated by heat.

### INDUSTRIAL APPLICABILITY

The present disclosure can be used for an electrolytic capacitor that is required to have excellent withstand voltage and has a high rated voltage.

### REFERENCE MARKS IN THE DRAWINGS

10: anode foil
20: cathode foil
30: separator
40: winding stop tape
50A, 50B: lead tab
60A, 60B: lead wire
100: wound body
200: electrolytic capacitor
211: bottomed case
212: sealing member
213: base plate

1. An electrolytic capacitor comprising a capacitor element, wherein:
the capacitor element includes:
an electrode group including an anode body and a cathode body; and
a conductive polymer component disposed between the anode body and the cathode body of the electrode group, and
the anode body includes:
a first base material containing a first valve metal; and
a first anodization film covering a surface of the first base material,
a first anodizing voltage Vfa applied to the first base material for forming the first anodization film is greater than or equal to 400 volts, and
a ratio Vfa/Vw of the first anodizing voltage Vfa to a rated voltage Vw of the electrolytic capacitor is greater than or equal to 2.10.

2. The electrolytic capacitor according to claim 1, wherein
the cathode body includes:
a second base material containing a second valve metal; and
a second anodization film covering a surface of the second base material, and
a second anodizing voltage Vfc applied to the second base material for forming the second anodization film is greater than or equal to 3 volts.

3. The electrolytic capacitor according to claim 2, wherein a ratio Vfc/Vfa of the second anodizing voltage Vfc to the first anodizing voltage Vfa is greater than or equal to 0.0040.

4. The electrolytic capacitor according to claim 1, wherein the surface of the first base material is roughened by a direct current etching method.

5. The electrolytic capacitor according to claim 1, wherein a thickness of the first anodization film is greater than or equal to 400 nm.

6. The electrolytic capacitor according to claim 1, further comprising a sugar alcohol in contact with the conductive polymer component.

7. The electrolytic capacitor according to claim 1, further comprising an electrolytic solution or a solvent.

8. A method for producing an electrolytic capacitor including a capacitor element, the method comprising:
a first step of obtaining an anode body including a first base material and a first anodization film covering a surface of the first base material by subjecting the first base material containing a first valve metal to an anodizing treatment at a first anodizing voltage Vfa;
a second step of preparing a cathode body;
a third step of obtaining an electrode group including the anode body and the cathode body; and
a fourth step of obtaining the capacitor element by interposing a conductive polymer component between the anode body and the cathode body of the electrode group, wherein:
the first anodizing voltage Vfa is greater than or equal to 400 volts, and
a ratio Vfa/Vw of the first anodizing voltage Vfa to a rated voltage Vw of the electrolytic capacitor is greater than or equal to 2.10.

9. The method according to claim 8, wherein:
the second step includes a step of obtaining the cathode body including a second base material and a second anodization film covering a surface of the second base material by subjecting the second base material containing a second valve metal to an anodizing treatment at a second anodizing voltage Vfc, and
the second anodizing voltage Vfc is greater than or equal to 3 volts.

10. The method according to claim 9, wherein a ratio Vfc/Vfa of the second anodizing voltage Vfc to the first anodizing voltage Vfa is greater than or equal to 0.0040.

11. The method according to claim 8, further comprising a step of subjecting the first base material to a surface roughening treatment by a direct current etching method, wherein in the first step, the first base material subjected to the surface roughening treatment is subjected to an anodizing treatment.

12. The method according to claim 8, further comprising step A of bringing a sugar alcohol into contact with the conductive polymer component.

13. The method according to claim 8, further comprising step B of impregnating the capacitor element with an electrolytic solution or a solvent.
